(19) United States
(12) Patent Application Publication
(10) Pub. No.: US 2022/0398678 A1
(43) Pub. Date: Dec. 15, 2022

(54) AUTOMATED SYSTEM TO FACILITATE REAL ESTATE TRANSACTIONS

(71) Applicant: J.E. Fox Company, Cottage Grove, MN (US)

(72) Inventor: Justin Fox, Cottage Grove, MN (US)

(21) Appl. No.: 17/806,880

(22) Filed: Jun. 14, 2022

Related U.S. Application Data
(60) Provisional application No. 63/210,842, filed on Jun. 15, 2021.

(51) Int. Cl. G06Q 50/16; G06Q 30/06

(52) U.S. Cl. CPC G06Q 50/167; G06Q 30/0625; G06Q 30/0641

(57) ABSTRACT

Automating the selecting, completing, and e-signing of real estate forms is disclosed. With third party data, and minimal user input, the user is able to create a complete a compliant contract or form package; include financial qualification information, if applicable; as well as obtain properly placed electronic signatures with minimal time and effort. Where documents require additional third-party action, the document is sent directly to that third party for immediate action.

### BACKGROUND

Problem Solved: Preparing an offer to purchase real property involves many steps, such as researching property characteristics; determining which legal requirements must be addressed based on property characteristics, broker representation, and location; determining which forms and documents are required to make a valid offer; determining which contingencies can be included in the offer; obtaining proof of the buyer's ability to finance the purchase; and more. This process is very time consuming and prone to mistakes.

Currently, real estate professionals must independently research property characteristics using unrelated third-party systems to determine which legal requirements must be addressed, determine the real estate brokers' agency types, determine contingencies that can be included, and determine which forms and documents must be used to address those legal requirements and contingencies. They must also independently contact the lender (if any) that will ultimately finance the purchase, and advise them of the property address, purchase price, and property tax amount, and ask them for proof of financing availability—usually in the form of a pre-approval or pre-qualification letter. Finally, the real estate professional uses software to select real estate forms from a list, completes them based on the previously mentioned research and the intent of their client. In many cases, this software is not capable of communicating or cooperating with the multiple databases and/or systems that contain necessary information. Then in a separate time-consuming step, obtain their clients' signatures, or electronic signatures, on those completed forms. Only after all of these steps are completed, can they present an offer to purchase real property, which often requires the use of separate communication tools. The system outlined below removes the need for all of the independent and separate steps, processes several types of data, provides the correct documentation, correctly completes the forms (without displaying the actual forms until completed), facilitates certain levels of communication, and substantially streamlines the process.

### BRIEF DESCRIPTION OF THE DRAWINGS

FIG. 1 is a drawing illustrating one embodiment of the possible components used in the system.

FIG. 2 shows a user interface displaying the user's active listings and pending sales that have been retrieved from a database or third-party vendor.

FIG. 3 shows the contextual menu for an active listing, where the user can select “Status Change,” or “Price Change” to generate forms using this invention. The user can select “Manage Signings” to access previous documents created using this invention, or to cancel signature requests created by this invention.

FIG. 4 shows an example of the input fields displayed to a user to generate a status change form and obtain electronic signatures from their client or customer. The client/customer information is obtained from a database 12. Once all parties have signed, the completed status change form is forwarded to all signers and to the user's administrative staff for further processing.

FIG. 5 shows an example of the input fields displayed to a user to generate a listing change form and obtain electronic signatures from their client or customer. The current list price and client/customer information is obtained from a database 12. Once all parties have signed, the completed status change form is forwarded to all signers and to the user's administrative staff for further processing.

FIG. 6 shows an example of a screen displayed on the user's device (16 or 18) which allows for the selection of a property.

FIG. 7 shows an example of a screen displayed on the user's device (16 or 18) for the collection of information related to a buyer.

FIG. 8 shows an example of a screen displayed on the user's device (16 or 18) for the collection of information related to potential terms of a purchase.

FIG. 9 shows an example of a screen displayed on the user's device (16 or 18) which allows for the collection of additional information.

FIG. 10 is a summary diagram showing the process involved in researching property characteristics, requesting and obtaining input, producing a complete document, obtaining electronic signatures, and sending the resulting completed document to a third party for further action.

FIG. 11 is a summary diagram showing the process involved in researching property characteristics, requesting and obtaining user input, producing a complete document and obtaining electronic signatures on the resulting completed document.

### DETAILED DESCRIPTION

As stated above, selecting, completing, and signing real estate documents, and/or the exchange of required information is error-prone and requires considerable amounts of time. The system and processes described below solves these problems.

The system described herein uses software running on a computing system. Using third party data about a subject property, which is of interest to a buyer, this software reviews that data, prompts the user for input related to the property and the desired action, determines the appropriate forms to be used, completes the forms, reduces errors, and assists in getting the forms executed. The documents produced may include disclosure documents, agency agreements, purchase agreements, contract addenda, contract amendments, escrow documents, estimates of sale proceeds, pre-qualification letters, among other things. It should be noted that the term “documents” is intended to be broadly interpreted, and may include paper documents, electronic documents, or electronic files that may exist as a functional equivalate or alternative to paper documents. Third party information includes property details, such as list or sale price, year built, water source, sewer provider, homeowners association information, address or other location date, legal descriptions, and contract details such as names and contact information, sale closing dates, contract expiration dates, and financing terms.

This system and processes differ greatly and are a stark improvement from what currently exists. Previously, a user would have to independently research a property's characteristics and location details using third party data to determine what documents, disclosures, and contingencies may be required and addressed. This software and related systems remove the need for all of the independent and separate steps, provides the correct documentation, correctly completes the forms (without displaying the actual forms until completed) and substantially streamlines the process. This system automates the process, coordinates communication between multiple systems, ensures accuracy, and maintains all levels of necessary security.

When selecting which forms are relevant, specific disclosures and related contingencies generally need to be included. If the wrong form is used, or a document or signature is missed, the agent/broker and their principal could violate laws or create additional liability, incur sanctions, or create an unenforceable contract.

Using third party data, and minimal user input, the user can create and complete a compliant contract or form package; include property-specific financial qualification letters; as well as obtain properly placed electronic signatures with minimal time and effort. Where documents require additional third-party action, the document is sent directly to that third party for immediate action.

Also, the system produces a completed and/or executed document or another legal contract.

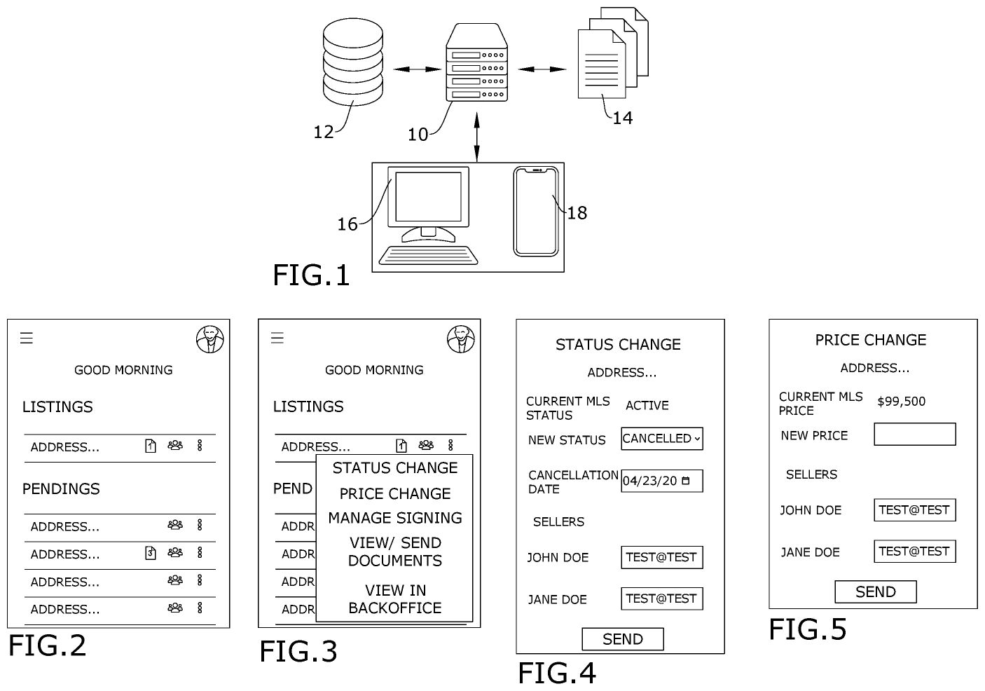

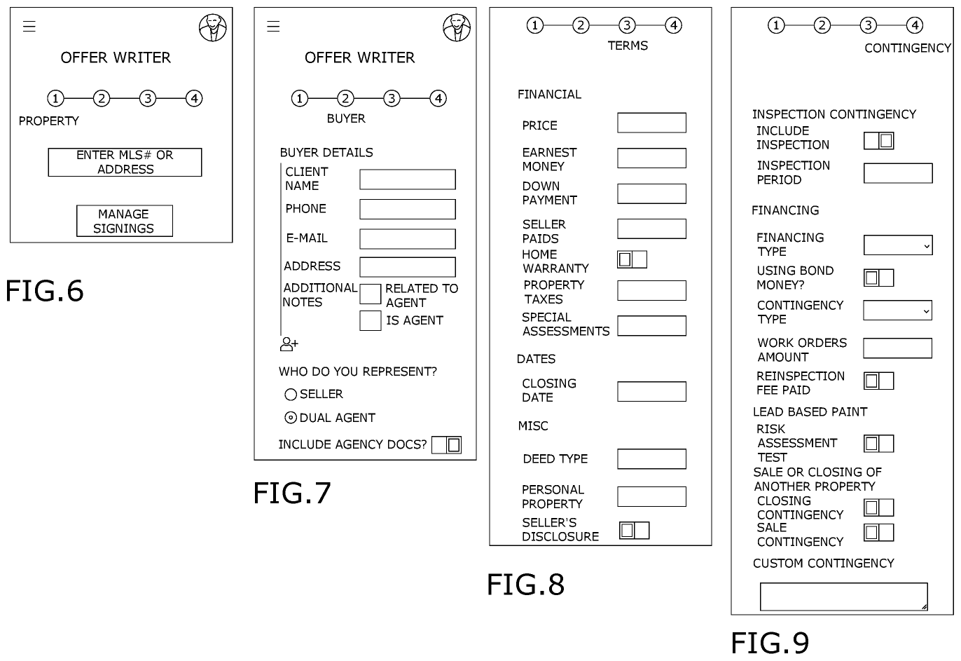

FIG. 1 generally illustrates one example of a system that can be used to carry out the automated process of preparing documents necessary for a real estate transaction. In this embodiment, the following components will interact with one another:

Database 12 can include a single database or a plurality of secure databases that store and hold information related to the real estate market and potential parties, including but not limited to user ids and passwords, contact information, real estate brokerage name and contact information, real estate brokerage specific logic and forms data, mortgage loan provider contact information, buyer and seller names and contact information, buyer loan qualification information, purchase offer terms, previous signature request data, locations of form files, locations of data fields located on form files, locations for placement of electronic signing blocks, real property data, real property listing data, and real estate agent contact information.

Digital storage repository 14 can include a physical or logical hard drive, that stores a plurality of forms, and documents. Examples of forms and documents include but are not limited to, disclosure documents, purchase agreements, purchase agreement addenda, bills of sale, agency contracts, lender preapproval letters, and completed documents.

User interface 16 can be an internet-connected computer for user interaction with the software, including but not limited to a keyboard, mouse, monitor, and printer. These devices communicate with server 10 over the internet using encryption such as Transport Layer Security, to keep all data secure.

Mobile device 18 allows for an alternative user interface, and may be an internet-connected mobile device, including but not limited to a tablet or mobile phone. These devices communicate with server 10 over the internet using encryption such as Transport Layer Security, to keep all data secure.

Server 10 represents an internet-connected computer, or server, hosting software that generates information to display to the user (via user interface 16 and/or mobile device 18), including but not limited to login prompts, property data, and on-screen questions with input fields to collect user input, allowing them to interact with the software; collects and processes input from the user; determines which database 12 to access to complete the users requested function; queries database 12 and temporarily caches the relevant retrieved data, and determines subsequent processes based on that data; if applicable it determines which forms, from digital storage repository 14, need to be accessed and temporarily cached to complete the desired task; generates printable savable documents in a standardized format, such as PDF, and displays generated documents to users via user interface 16 or mobile device 18, which can be printed or saved; saves generated documents, cached database information used to generate the documents, and all user input to a database 12 for auditing and future use; generates documents in a standardized format, such as PDF, that can be sent to an electronic signature vendor, with signature/input locations and signer information, to collect electronic signatures/input, and emails or displays fully executed and completed documents to the user and signer(s), and depending on the users selected task, emails the completed document to a third party (generally administrative staff) for additional tasks unrelated to this invention.

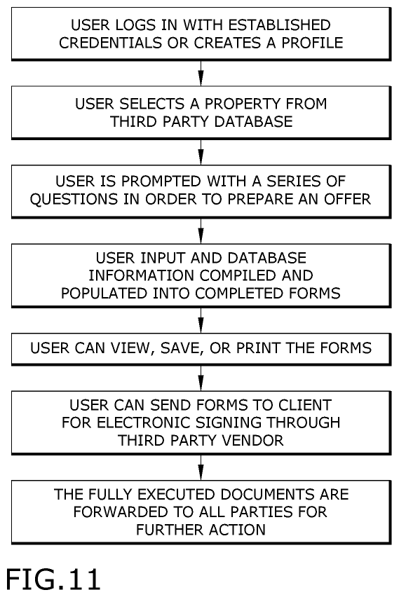

Outlined below, and shown in FIG. 11, is one example of how the system works:

Step 1. After completing a sign-in or login process, Host server (10) sends data to the user's device (16 or 18) prompting them to select a subject property. In its current form, the user enters identifying information, such as an address or listing identification number, into a freeform input field using their device (16 or 18). Each time the user inputs characters into the input field, that data is sent to the host server (10), to carry out a search optimization process, which sanitizes the input (removing characters that could cause unintended actions, such as a server compromise, to take place), replaces space characters with wildcard characters to broaden the search, and then makes an inquiry to a plurality of databases (12) for properties matching the modified search information. The host server (10) parses the data returned from the databases (12), removes any characters, or sequences of characters, that could cause unintended actions on the server (10), and sends identifying information, such as address, database identification number, and listing identification number, to the user for display on their device (16 or 18) as a menu. As the user continues to input characters, the number of search results narrows, allowing the user to quickly select the relevant subject real property. Property selection could also be performed by other means, including but not limited to geo location or list searching techniques.

Step 2. When the user selects a property using their device (16 or 18), the database identification number or listing identification number is sent back to the server (10). The server (10) reviews the input and optimizes the search (e.g. removes any characters, or sequences of characters, from the users input that could cause unintended actions to take place on the server) and makes an inquiry to a database(s) (12) for more detailed information about the subject property. The server (10) reviews the returned detailed property information, and again removes any characters, or sequences of characters, that could cause unintended actions on the server (10), and extracts the identifying information of any real estate salespersons and/or brokers associated with the property. The server (10) makes an inquiry to another database(s) (12) for detailed information about that real estate salesperson(s) and/or broker(s). The detailed property and salesperson and/or broker information returned to the server (10) by the databases (12) is parsed to remove any characters, or sequences of characters, that could cause unintended actions on the server (10), and then stores the results in the server's (10) memory, or in another database (12), and associates it with the user in a session (either on the server (10), or in a database (12), or other session-management-type system). Information, such as a cookie, may be temporarily stored on the user's device (16 or 18) to associate their device with that session, and thereby the previously saved data—doing so can reduce the number of inquiries to the database(s) (12) and thereby reduce response times. The server sends more detailed identifying information to the user for display on their device (16 or 18), such as the complete property address, and any related agent(s) and/or broker(s) along with their contact information, to confirm their property selection. The agent(s) and/or broker(s) phone number(s) is displayed within a hyperlink, where the phone number is embedded within it, so that the user can click on the phone number to dial it. The agent(s) and/or broker(s) email address is also displayed within a hyperlink, where the email address is embedded within it, so that the user can click the email address to automatically open their email client and send that address an email message.

Step 3. On the user device (16 or 18), when the user confirms the correct property was selected, that input is sent to the server (10), which removes any characters, or sequences of characters, that could cause unintended actions to take place on the server (10). The server (10) makes an inquiry to a database(s) (12) of real estate licenses to obtain a list of licenses held by the user. The server (10) extracts the state of the subject property from the detailed property data previously stored in step 2 and compares the subject property's state to the list of licenses held by the user; if the user holds a valid license in the state where the property is located, the process continues; if not, the server (10) sends a message to the user for display on their device (16 or 18) that they are not licensed in the state of the property and are therefore, not allowed to proceed at which time the process stops. The server (10) extracts the salesperson(s) and/or broker(s) information related to the subject property from the data previously stored in step 2 and then makes an inquiry to a database(s) (12) of offices associated with the user and/or their broker, looking for matches, to see if the agent(s) and/or broker(s) associated with the subject property are within the same brokerage as the user. If that process determines the user and the agent(s) and/or broker(s) associated with the subject property are within the same brokerage, the server (10) uses preprogramed logic to determine what brokerage representation options are available to the user (such as dual agency, seller agency, subagency, designated agency, facilitation, etc)—this logic and these options could also be stored in a database (12). The server (10) sends data to the user for display on their device (16 or 18), which prompts them to enter the contemplated buyer(s) identifying and contact information (such as name, email address, phone number, address), or select the buyer(s) from their device's (16 or 18) contact list, any add other data about the buyer that might be pertinent to include in an offer (familial relation to user, real estate license status), and prompts them to select from any available representation types previously calculated by the server (10) (buyer broker, seller broker, dual broker, etc), as well as if they want to include any related agency documents (disclosures, brokerage agreements, etc). All calculated and entered data is stored in the server's (10) memory, or in another database (12), and associated with the user in a session (either on the server (10), or in a database (12), or other session-management-type system).

Step 4. The user input is submitted to the server (10), which removes any characters, or sequences of characters, that could cause unintended actions to take place on the server (10). The server (10) extracts the buyer(s) email addresses, or other identifying information, and queries a database(s) (12) of buyers that have been approved for financing by participating mortgage lender(s). If found, the server (10) extracts the lender and lender firm information from that data and queries one or more additional database(s) (12) for detailed information about each lender and lender firm. The server (10) extracts the detailed property data previously stored in step 2 (such as city, county, state, association fee amount, legal description, legal structure, etc) and reviews user/brokerage pre-programmed rules/logic, either stored on the server (10), or stored in a database(s) (12), for any matching preferences and/or requirements—either user specific and/or user brokerage specific, and/or property specific based on the rules/logic. Matches could include user and/or broker specific defaults, state or county specific requirements and contract form fields, contingencies for local customs, contract terms based on property characteristics (condominium, townhouse, waterfront, homeowners associations, age, etc), or other regulations; this can also include if/then type input requests, such as if the user checks a box to include a home warranty in their offer, then another data field(s) will be displayed to the user to prompt them to enter details about the included warranty (max cost, term, issuer, etc). The rules/logic are typically created by the brokerage of the user, who is or should be aware of contract terms and local customs and requirements; although it could be created by an attorney, real estate trade association, or other qualified party. In situations where the brokerage, or other qualified party, determine that the user should review property-specific information, such as legal description, or personal property to include in an offer, additional information from the detailed property data may be sent to the user's device (16 or 18) for display to the user for their selection, confirmation, and/or input. The server (10) then sends data to the user's device (16 or 18) which displays any/all matching mortgage lender and lender firms, with a prompt to select one if the user wishes to include a corresponding pre-approval letter with their offer package. It also prompts the user to enter financial terms such as offer price (this particular field displays the current list price as a placeholder, if available from the detailed property data, so that the user can consider that information as they prepare their offer), earnest money/deposit amount, down payment amount, any other terms determined to be applicable based on the rules/logic functions performed in this step and any corresponding display data. If personal property is to be included in the offer, an input field is displayed to the user that is pre-filled with any personal property data that is included in the detailed property information from step 2. The user is also prompted to enter a closing date, this field is tied to a pop-up calendar so that the user can select the closing date using a calendar if desired. All calculated and entered data is stored in the server's (10) memory, or in another database (12), and associated with the user in a session (either on the server (10), or in a database (12), or other session-management-type system).

Step 5. Upon completion of the selections mentioned above, the user input is submitted to the server (10), which removes any characters, or sequences of characters, that could cause unintended actions to take place on the server (10). The server (10) compares the input against itself for accuracy (for example, the earnest money cannot exceed the purchase price, the closing date must be a valid date that is not in the past, the down payment cannot be more than the purchase price, etc). If the down payment entered is a number higher than 100, it is processed as an amount, if it is equal to or less than 100, it is processed as a percentage. If the down payment is 100, the system considers it a cash offer without financing and can remove any corresponding financing contingencies; if the down payment is between 0 through 99, it is considered a financed offer. If financing is involved, the server (10) calculates the buyer's loan amount by subtracting the down payment amount entered by the user, or in the case of a percentage down payment entry, it subtracts the down payment amount from 100 and then multiplies that with the offer price. If financing is involved and the user had selected a pre-approval letter in this step, the server (10) queries a database (12) for financing information specific to the pre-approval letter selected, which includes information such as the buyer(s) name, email address, financing type (conventional, FHA, VA, etc), what type (if any) bond money is to be used, interest rate, loan term, private mortgage insurance premium, estimated annual homeowners insurance, maximum approved payment amount, expiration of the pre-approval, and instructions/notes to the user, among other things). The principal and interest payment is calculated based on the loan amount calculation described above and the interest rate and term returned from the database (12). If mortgage insurance information was included in the database (12) information, the server (10) calculates the monthly premium amount. The server (10) calculates the monthly amount of homeowners insurance using information from the lender, or this information could also be estimated mathematically using a percentage of the purchase price if not entered by the lender. The server (10) extracts the property tax amount, and any association or other fees that would be considered in mortgage qualification from the detailed property information saved previously in step 2. The server (10) calculates a monthly amount for property taxes by dividing the annual property tax amount by 12. The server (10) takes any homeowners association amounts and converts them to a monthly number, for example if the data includes an annual association fee, that fee would be divided by 12, quarterly would be divided by 3, etc. Once these calculations are complete, the total monthly amount is added up and compared to the maximum payment amount entered by the lender, if the calculated amount is less than the maximum payment, a mortgage pre-approval letter can be included in the offer. That information is stored in the server's (10) memory, or in another database (12), and associated with the user in a session (either on the server (10), or in a database (12), or other session-management-type system) along with any information was returned from the database (12) for display to the user. The server (10) extracts the detailed property data previously stored in step 2 (such as city, county, state, association fee amount, legal description, legal structure, etc) and reviews user/brokerage pre-programmed rules/logic, either stored on the server (10), or stored in a database(s) (12), for any additional matching preferences and/or requirements—either user specific and/or user brokerage specific, and/or property specific based on the preprogramed rules/logic. In some cases, the user's previous input will eliminate the need for certain contingencies (such as financing, etc); the user's previous input could create a need to include additional contingencies or provisions (such as financing, etc). The server (10) sends the calculated questions, and any applicable financing information, to the user's device (16 or 18) and prompts them for further input. All calculated and entered data is stored in the server's (10) memory, or in another database (12), and associated with the user in a session (either on the server (10), or in a (12), or other session-management-type system).

Step 6. Upon completion of the above-mentioned questions, the user input is submitted to the server (10), which removes any characters, or sequences of characters, that could cause unintended actions to take place on the server (10). The server (10) reviews the input for accuracy and/or errors. The users input from all previous steps is tabulated and sent back to the user's device (16 or 18) for review and confirmation as well as a prompt to view, save, or print the completed document(s) to their device (16 or 18), or to send the completed document(s) directly to the buyer(s) for electronic signature. Alternatively, the user can go back and adjust their input. All calculated and entered data is stored in the server's (10) memory, or in another database (12), and associated with the user in a session (either on the server (10), or in a database (12), or other session-management-type system).

Step 7. If the user selects print/save/view or e-sign, that selection is sent to the server (10), which removes any characters, or sequences of characters, that could cause unintended actions to take place on the server (10). The server (10) extracts the detailed property data previously stored in step 2, previous input, and user/brokerage pre-programmed rules/logic, either stored on the server (10), or stored in a database(s) (12), for any additional matching preferences and/or requirements—either user specific and/or user brokerage specific, and/or property specific based on the rules/logic and determines which documents, disclosures, and/or addenda need to be included to create a complete document or document package, queries a database (s) (12) for fillable field names and the location of the document, disclosure, and/or addenda in document storage (14) of each of those documents, disclosures, and/or addenda; then creates a temporary file for each document to store the field names and corresponding values on the server (10) or document storage (14), saving the document name and location to memory on the server (10) or database (12). Each of these documents is then systematically applied to its corresponding fillable form from document storage (14), whereby the form is filled out and saved on the server (10) or document storage (14). Each completed document, disclosure, and/or addenda is merged into one document and saved to the server (10) or document repository (14); the users input, and property details are saved to a database (12) for auditing purposes and/or future use. If the user selected print/save/view, the resulting document is sent to the user's device (16 or 18) in PDF (or other) format to view, print, or save. If the user selects e-sign, the server queries a database or databases (12) for locations of placement for buyer signatures, initials, or other input on each individual document, disclosure, and/or addenda; the previously saved information about each form is ordered to match the order of the merged documents, so that signatures can be placed on the appropriate pages and forms. That data is sent along with each buyer's name and contact information, and the resulting document to a third-party e-signature platform to obtain buyer(s)' electronic signatures.

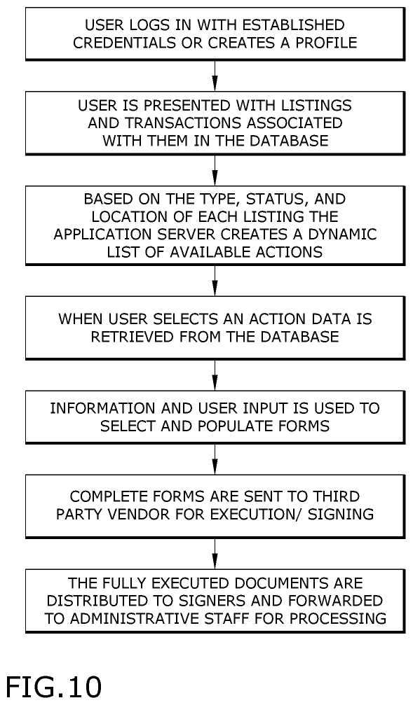

Another example of how the system works is summarized in FIG. 10, and is described in detail below:

Step 1. After completing a sign-in or login process, the Host server (10) makes an inquiry to a plurality of databases (12) for listings and sales associated with the user, and then makes another inquiry to at least one additional database (12) for each of the previously retrieved listings and sales associated with the user to find previously created electronic signature document packages or contract amendments, associated with each of those listings and/or sales. The search results are reformatted and sent to the user's device (16 or 18) to include identifying information, such as address and listing ID number, as well as list/sale price, sale closing date, listing expiration date, contract status, among other things (FIG. 2). The contents of a contextual menu, for additional user action, are calculated based on listing/contract status and type of client representation (such as buyer or seller), and existence of previously created client e-signing requests associated with that listing or transaction (FIG. 3) and then sent to the user's device (16 or 18) but hidden for later display upon selection by the user.

Step 2. If the user selects the contextual menu button next to a listing or transaction, the hidden menu for that was calculated in step 1, is displayed (FIG. 3). The following processes would only be displayed and available if the calculations in step 1 provided for them:

a. Status Change: If the user selects status change, the user's device notifies the server (10) and simultaneously displays a status change window (FIG. 4) for population by the server's (10) response to the notification.

i. The server (10) receives the notification, removes any characters from it that could cause unintended actions to be performed, and queries at least one property database (12) for detailed property information, including the MLS or similar, listing status (for example Active, Pending, Withdrawn, etc); the server (10) then queries at least one database (12) for a list of available statuses based on the results of the previous database inquiry; based on the results of the previous database inquiries, the server (10) determines if it should make another database inquiry (12) for a list of available contingencies (specific to the existing status, and the geographic location of the property) to include with the updated or existing listing status, and then stores the results in the server's (10) memory, or in another database (12), and associates it with the user in a session (either on the server (10), or in a database (12), or other session-management-type system). Information, such as a cookie, may be temporarily stored on the user's device (16 or 18) to associate their device with that session, and thereby the previously saved data—doing so can reduce the number of inquiries to the database(s) (12) and thereby reduce response times

ii. The server (10) populates the status change window displayed on the user's device (16 or 18) with identifying information for the listing or sale, such as address, along with the listing or sale's current status; the available status changes are populated into a selection menu for user input, and the associated contingencies are formatted into another selection menu that remains hidden from the user;

iii. If the user selects a new status from the available statuses, the user's device (16 or 18) determines if the new status allows for a contingency; if so, the hidden selection menu from paragraph ii is displayed on the user's device (16 or 18). The user's device (16 or 18) simultaneously notifies the server (10) of the selection;

iv. The server (10) receives the input, removes any characters that would cause unintended actions to take place, and based on pre-programmed logic and the information previously saved in paragraph i, determines if the user's selection requires addition user input, as well as whether a contract amendment is required in order to complete the user's request. If the server (10) determines that additional information is required, it sends additional relevant input fields to the user's device (16 or 18) for completion. If the server (10) determines that a contract amendment is required, it then queries at least one database (12) to obtain a list of contacts associated with the listing or transaction; the server (10) extracts the names and contact information for the client(s) (if available), and sends the client(s) names and contact information to the user's device (16 or 18), where the client(s) contact information is populated into text input fields for confirmation by the user in a format similar to FIG. 4.

v. Price Change: If the user selects price change, the user's device notifies the server (10) and simultaneously displays a price change window (FIG. 5) for population by the server's (10) response to the notification. The server (10) queries at least one property database (12) for detailed property information, including the current price, and then stores the results in the server's (10) memory, or in another database (12), and associates it with the user in a session (either on the server (10), or in a database (12), or other session-management-type system). Information, such as a cookie, may be temporarily stored on the user's device (16 or 18) to associate their device with that session, and thereby the previously saved data—doing so can reduce the number of inquiries to the database(s) (12) and thereby reduce response times. The server (10) then queries at least one database (12) to retrieve the client(s) name and contact information. The server (10) sends the current price, an input field for the new price, and the client(s) name(s) and contact information on the user's device (16 or 18), where the contact information is populated into text input fields for confirmation by the user in a format similar to FIG. 5.

Step 3. The user completes and/or verifies the input fields and submits the information on their device (16 or 18) to the server (10), which receives the data and removes any characters from it that could cause unintended actions to be performed.

Step 4. If, based on pre-programmed logic, the server (10) previously determined that a document or contract amendment needed to be executed, it reviews the location and contract status data saved in previous steps. Based on pre-programmed logic, the server (10) determines which form(s) is required to complete the user's desired task and makes an inquiry to one or more databases (12) to retrieve a list of the form input fields and the location of the form file(s) in the document storage (14). The server (10) compares the form fields with property data previously retrieved and saved, such as address information, and with the user's submitted input, and then creates a temporary file for each form file to store the field names and corresponding values on the server (10) or document storage (14), saving the document name and location to memory on the server (10) or database (12). Each of these documents is then systematically applied to its corresponding fillable form from document storage (14), whereby the form is filled out and saved on the server (10) or document storage (14). Each completed form or amendment is merged into one document and saved to the server (10) or document repository (14); the users input, and property details are saved to a database (12) for auditing purposes and/or future use. The server (10) queries a database or databases (12) for locations of placement for buyer signatures, initials, or other input on each individual form, and/or amendment; the previously saved information about each form is ordered to match the order of the merged documents, so that signatures can be placed on the appropriate pages and forms. That data is sent along with each buyer's name and contact information, and the resulting document to a third-party e-signature platform to obtain buyer(s)' electronic signatures.

a. Upon completion of the third-party e-signature process, the third-party notifies the server (10) of completion. The server (10) queries the third-party for a fully executed copy of the document, saves it on the server (10) or document repository (14), prepares an email, attaches the document to it, and sends it to all signing parties; sends a notification to database(s) (12) to update the information changed via the executed document or amendment; and optionally:

i. prepares an email, attaches the document to it, and forwards the document to a designated third party for additional action (such as changing the status or price in an MLS or other database)

ii. contacts a third-party application programming interface(s) (API) to complete the changes specified in the form or contract amendment (such as changing the status or price in the MLS or other database)

Step 5. If, based on pre-programmed logic, the server (10) determines that a document or contract amendment is not required in order to make the user's request change, it:

a. prepares and sends an email containing the users selections and input to a designated third party for additional action (such as changing the status or price in an MLS or other database)

b. contacts a third-party application programming interface(s) (API) to complete the changes specified by the user (such as changing the status or price in the MLS or other database)

Step 6. Upon completion, the server (10) sends a notification to the user's device (16 or 18) that the change has been completed.

While it could take many forms, the system capable of providing the benefits outlined above includes software that is able to complete the requisite tasks and provide the user with the useful tool described hereabove. As such, the system can be implemented in a number of ways.

A user would not need to use both a mobile device, and a computer and its associated peripherals and input devices—the tools could be implemented using one or the other. The user would not need a printer. That said, any combination of components can be used, depending upon user preferences and equipment availability.

This can be completed in device specific applications (mobile app, computer application) as opposed to a web-based application as well, provided necessary computing and communication resources are available.

Using the system is straight forward and intuitive. In another embodiment, use of the system will follow the following steps:

Step 1. Using a computer or mobile device, the user logs into the software. The user (real estate agent/broker) is presented with a list of listings and transactions they are associated with (from database or other third party, such as in FIG. 2), then based on the location and status of those listings and transactions, the software creates a contextual menu for those listings and transactions such as: change status, cancel, or change contract term (such as in FIG. 3). Some of those actions require specific documents to be completed and signed by the user and/or their client/principal. In this case, based on the user's selected action and property specific details, a dynamic list of question(s), along with the client's name and email address are displayed (such as in FIGS. 4 and 5). The user answers the question(s) and submits them to the software. In a process that is transparent to the user, the software determines the appropriate document/form based on the desired action and location of the property (some have state-specific forms), completes all of the relevant fields, and sends it to the client/principal for electronic signature. Once the client/principal signs electronically, the executed document is emailed to the client/principal, the user, and the user's administrative staff so that they can process the action/change with no further action required on the user's part.

Step 2. If the user wishes to prepare an offer to purchase real property for their client, they enter identifying information for that property (address, listing id number, etc). Properties matching the user's input are displayed as they type. The user can quickly select the desired property to continue creating a document/offer package. The user is then prompted to enter identifying information for their client (such as name and email address), if accessed via mobile device, they can select a contact from that device for easy insertion. Based on third party listing information, the software determines the agency status of the listing and offers the user the legally available agency representation types for their client, for example Buyer Agency, Facilitation (where legal), Seller Agency, or Dual Agency (where legal). The user is prompted to included state mandated agency disclosures and representation contracts, if desired. Next, the software searches the database for the buyers entered in the previous step; if found, a list of lenders that are associated with that buyer are displayed as available to include along with the contract documents as proof of financial ability. Next, the software requests the user enter offer terms specifically based on the property characteristics previously retrieved from the database(s) and previously entered by the user—any relevant information available from the third-party database is prepopulated into the answer section of the questions as hints and/or suggestions. Next, if applicable, the software calculates the monthly payment for the buyer based on the user's previous input (including but not limited to purchase price, down payment), the property's financial characteristics (including but not limited to property taxes, association fees), and information previously supplied by the buyer's lender (including but not limited to interest rate, mortgage insurance factor, loan term, maximum allowed monthly payment) and then compares that calculation to qualification information entered by the buyer's loan officer. If the calculated payment fits within the lender's qualification guidelines, a property-specific pre-approval/pre-qualification letter is included in the document package; if not, a message is displayed to the user advising them to call the lender and that a pre-approval/pre-qualification letter could not be included—in this case a pre-approval/pre-qualification letter is not included in the document package. Next, the user is prompted for terms of any relevant contingencies (based on data from the property database). Based on information from the property database and user's input, in a process transparent to the user, the correct forms, disclosures, and contingencies are selected and completed with any selected financial qualification information included. The user may print or save the completed documents and may send them to the client for electronic signature with minimal additional action. Completed electronically signed documents are emailed directly to the signers and the user.

Additionally: This system, or the processes described, could be used in any situation where forms are selected and completed by a user, as well as when those forms need to be signed by other parties. Also, the system produces a completed and/or executed document or other details required to form a legal contract.

Various embodiments of the invention have been described above for purposes of illustrating the details thereof and to enable one of ordinary skill in the art to make and use the invention. The details and features of the disclosed embodiments are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A process to facilitate the completion of a real estate transaction, including the researching property characteristics, regulations, financing details, processing of data, normalizing data from a plurality of sources, collecting relevant user input, and preparing a collection of required forms, the process comprising:
using programmed logic to request and receive search input data from a user, the search input data characterizing the user's desired research task, wherein the search input data is received via a user interface on a user device;
normalizing the search input data, formulating a property search, and carrying out the property search using at least one database;
receiving property search results which identify at least one property and reformatting the property search results to be presented to the user;
forwarding the reformatted property search results to the user device;
using programmed logic allowing the user to select a property contained within the property search results and to initiate a form completion process, wherein the form completion process comprises the user inputting additional information via the user interface, wherein the additional information is dependent upon the property selected;
searching a plurality of databases for additional information related to the selected property and the user, wherein the plurality of databases include at least one of a property details database, a regulations database, broker preferences/rules database, contact information database, license database, forms database, placement database, and a financing database;
using programmed logic to review the additional information related to the property and the user, selecting relevant forms, calculating data for the selected forms, determining additional information needed to complete the selected forms, and prompting a user for the corresponding input;
using the compiled information and additional information, performing calculations, and preparing data in a form necessary to create a document package, wherein the document package includes the completed forms; and
coordinating the collection of at least one electronic signature related to the documents.

2. The process of claim 1 wherein the selected forms comprise a purchase agreement and a disclosure form.

3. The process of claim 1 wherein the document package comprises a purchase agreement which includes financial qualification information.

4. The process of claim 1 wherein the document package comprises a plurality of forms that could include a purchase agreement, addenda, additional agreements, and/or disclosures.

5. The process of claim 1 wherein the document package comprises a plurality of forms that could include a contract for listing real property for sale, disclosures, and additional agreements.

6. The process of claim 1 wherein one or more of the database inquiries is made to a third-party application programming interface instead of to one or more databases.

7. The process of claim 1 wherein the document package is printed, viewed, or saved without obtaining electronic signatures.

8. A process to facilitate the amendment of an existing contract, including the researching property characteristics, existing contract status and terms, parties to and existing contract, processing of data, normalizing data from a plurality of sources and preparing a collection of required forms, the process comprising:
using programmed logic to formulate a property search, and carrying out the property search using at least one database;
receiving property search results which identify at least one property and reformatting the property search results to be presented to the user;
forwarding the reformatted property search results to the user device;
using programmed logic allowing the user to select a property contained within the property search results and to initiate a form completion process, wherein the form completion process comprises the user inputting additional information via the user interface;
searching a plurality of databases for additional information related to the selected property and the user, wherein the plurality of databases include at least one of a property details database, a regulations database, broker preferences/rules database, contact information database, existing contract database, license database, forms database, and a placement database;
using programmed logic to review the additional information related to the property and the user, selecting relevant forms, calculating data for the selected forms, determining additional information needed to complete the selected forms, and prompting a user for the corresponding input, wherein the determination of additional information is dependent upon the selected property;
using the compiled information and additional information, performing calculations, and preparing data in a form necessary to create a document package, wherein the document package includes the completed forms; and
coordinating the collection of at least one electronic signature related to the documents;

9. The process of claim 8 wherein the document package contains a contract amendment or amendments.

10. The process of claim 8 wherein one or more of the database inquiries is made to a third-party application programming interface instead of to one or more databases.

11. The process of claim 8 wherein the document package is printed, viewed, or saved without obtaining electronic signatures.

12. The process of claim 1 wherein selecting relevant forms, calculating data for the selected forms, determining additional information needed to complete the selected forms is dependent upon the user's search and a set of related calculations. .

13. The process of claim 1 wherein the services are made available to a plurality of users.

14. The process of claim 1 wherein the user inputs specifically requested information without viewing the forms until after the process completes the forms.

15. The process of claim 8 wherein selecting relevant forms, calculating data for the selected forms, determining additional information needed to complete the selected forms is dependent upon the user's search and a set of related calculations.

16. The process of claim 8 wherein the services are made available to a plurality of users.

17. The process of claim 8 wherein the user inputs specifically requested information without viewing the forms until after the process completes the forms.
